(19) United States
(12) Patent Application Publication
(10) Pub. No.: US 2025/0351214 A1
(43) Pub. Date: Nov. 13, 2025

(54) RADIO LINK FAILURE TECHNIQUES FOR LOW-LATENCY TRAFFIC

(71) Applicant: QUALCOMM Incorporated, San Diego, CA (US)

(72) Inventor: Linhai HE, San Diego, CA (US)

(21) Appl. No.: 19/196,277

(22) Filed: May 1, 2025

Related U.S. Application Data
(60) Provisional application No. 63/645,015, filed on May 9, 2024.

(51) Int. Cl. H04W 76/19; H04L 1/18

(52) U.S. Cl. CPC H04W 76/19; H04L 1/18

(57) ABSTRACT

Methods, systems, and devices for wireless communications are described that provide radio link failure (RLF) in accordance with RLF criteria associated with relatively low-latency applications. The RLF criteria may provide that when a radio link control (RLC) protocol data unit (PDU) of a low-latency RLC entity has been transmitted for a threshold quantity of times a transmitter may remove the PDU from a retransmission buffer and record one retransmission failure. RLF may be triggered by the transmitter based on a time-window associated with recorded retransmission failures, or based on a counter-based condition associated with the recorded retransmission failures. For the time-window-based condition, if there are at least a threshold quantity of retransmission failures with a time window, RLF may be triggered. For the counter-based condition, if a count of retransmission failures reaches a configured threshold value prior to expiration of a timer, RLF may be triggered.

### CROSS REFERENCE

The present Application for Patent claims the benefit of U.S. Provisional Patent Application No. 63/645,015 by Linhai HE, entitled “RADIO LINK FAILURE TECHNIQUES FOR LOW-LATENCY TRAFFIC,” filed May 9, 2024, assigned to the assignee hereof, and expressly incorporated by reference herein.

### FIELD OF TECHNOLOGY

The following relates to wireless communications, including radio link failure techniques for low-latency traffic.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting two or more instances of a first protocol data unit (PDU) via a radio link, the two or more instances of the first PDU including an initial transmission of the first PDU and one or more retransmissions of the first PDU, removing the first PDU from a retransmission buffer based on a determination that a quantity of retransmissions of the first PDU meets a PDU retransmission limit value, recording a retransmission failure based on the determination that the quantity of retransmissions of the first PDU meets the PDU retransmission limit value, and triggering a radio link failure (RLF) and initiating a connection re-establishment procedure for the radio link based on a quantity of recorded retransmission failures within a time duration exceeding a retransmission failure threshold value.

A UE for wireless communications is described. The UE may include one or more memories storing processor executable code, and one or more processors coupled with the one or more memories. The one or more processors may individually or collectively be operable to execute the code to cause the UE to transmit two or more instances of a first PDU via a radio link, the two or more instances of the first PDU including an initial transmission of the first PDU and one or more retransmissions of the first PDU, remove the first PDU from a retransmission buffer based on a determination that a quantity of retransmissions of the first PDU meets a PDU retransmission limit value, record a retransmission failure based on the determination that the quantity of retransmissions of the first PDU meets the PDU retransmission limit value, and trigger a RLF and initiating a connection re-establishment procedure for the radio link based on a quantity of recorded retransmission failures within a time duration exceeding a retransmission failure threshold value.

Another UE for wireless communications is described. The UE may include means for transmitting two or more instances of a first PDU via a radio link, the two or more instances of the first PDU including an initial transmission of the first PDU and one or more retransmissions of the first PDU, means for removing the first PDU from a retransmission buffer based on a determination that a quantity of retransmissions of the first PDU meets a PDU retransmission limit value, means for recording a retransmission failure based on the determination that the quantity of retransmissions of the first PDU meets the PDU retransmission limit value, and means for triggering a RLF and initiating a connection re-establishment procedure for the radio link based on a quantity of recorded retransmission failures within a time duration exceeding a retransmission failure threshold value.

A non-transitory computer-readable medium storing code for wireless communications is described. The code may include instructions executable by one or more processors to transmit two or more instances of a first PDU via a radio link, the two or more instances of the first PDU including an initial transmission of the first PDU and one or more retransmissions of the first PDU, remove the first PDU from a retransmission buffer based on a determination that a quantity of retransmissions of the first PDU meets a PDU retransmission limit value, record a retransmission failure based on the determination that the quantity of retransmissions of the first PDU meets the PDU retransmission limit value, and trigger a RLF and initiating a connection re-establishment procedure for the radio link based on a quantity of recorded retransmission failures within a time duration exceeding a retransmission failure threshold value.

In some examples of the method, UEs, and non-transitory computer-readable medium described herein, the time duration may be configured based on a delay budget associated with the first PDU. Some examples of the method, UEs, and non-transitory computer-readable medium described herein may further include operations, features, means, or instructions for receiving configuration information for the radio link that indicates the PDU retransmission limit value and the retransmission failure threshold value. In some examples of the method, UEs, and non-transitory computer-readable medium described herein, the radio link may be associated with low-latency traffic, and where radio links associated with non-low-latency traffic use different criteria to trigger the RLF. In some examples of the method, UEs, and non-transitory computer-readable medium described herein, the configuration information for the radio link further indicates the time duration.

In some examples of the method, UEs, and non-transitory computer-readable medium described herein, the PDU retransmission limit value may be based on a delay budget associated with the first PDU to provide that retransmissions of the first PDU are discontinued after a time period associated with the delay budget. Some examples of the method, UEs, and non-transitory computer-readable medium described herein may further include operations, features, means, or instructions for resetting a count of retransmission failures when the time duration expires, and initiating a subsequent count of retransmission failures in a subsequent time duration. In some examples of the method, UEs, and non-transitory computer-readable medium described herein, the radio link may be configured for acknowledged mode communications.

A method for wireless communications by a UE is described. The method may include transmitting two or more instances of a first PDU via a radio link, the two or more instances of the first PDU including an initial transmission of the first PDU and one or more retransmissions of the first PDU, removing the first PDU from a retransmission buffer based on a determination that a quantity of retransmissions of the first PDU meets a PDU retransmission limit value, recording a retransmission failure based on the determination that the quantity of retransmissions of the first PDU meets the PDU retransmission limit value, and triggering a RLF and initiating a connection re-establishment procedure for the radio link based on a count of recorded retransmission failures that meets a count limit value prior to an expiration of a timer.

A UE for wireless communications is described. The UE may include one or more memories storing processor executable code, and one or more processors coupled with the one or more memories. The one or more processors may individually or collectively be operable to execute the code to cause the UE to transmit two or more instances of a first PDU via a radio link, the two or more instances of the first PDU including an initial transmission of the first PDU and one or more retransmissions of the first PDU, remove the first PDU from a retransmission buffer based on a determination that a quantity of retransmissions of the first PDU meets a PDU retransmission limit value, record a retransmission failure based on the determination that the quantity of retransmissions of the first PDU meets the PDU retransmission limit value, and trigger a RLF and initiating a connection re-establishment procedure for the radio link based on a count of recorded retransmission failures that meets a count limit value prior to an expiration of a timer.

Another UE for wireless communications is described. The UE may include means for transmitting two or more instances of a first PDU via a radio link, the two or more instances of the first PDU including an initial transmission of the first PDU and one or more retransmissions of the first PDU, means for removing the first PDU from a retransmission buffer based on a determination that a quantity of retransmissions of the first PDU meets a PDU retransmission limit value, means for recording a retransmission failure based on the determination that the quantity of retransmissions of the first PDU meets the PDU retransmission limit value, and means for triggering a RLF and initiating a connection re-establishment procedure for the radio link based on a count of recorded retransmission failures that meets a count limit value prior to an expiration of a timer.

A non-transitory computer-readable medium storing code for wireless communications is described. The code may include instructions executable by one or more processors to transmit two or more instances of a first PDU via a radio link, the two or more instances of the first PDU including an initial transmission of the first PDU and one or more retransmissions of the first PDU, remove the first PDU from a retransmission buffer based on a determination that a quantity of retransmissions of the first PDU meets a PDU retransmission limit value, record a retransmission failure based on the determination that the quantity of retransmissions of the first PDU meets the PDU retransmission limit value, and trigger a RLF and initiating a connection re-establishment procedure for the radio link based on a count of recorded retransmission failures that meets a count limit value prior to an expiration of a timer.

In some examples of the method, UEs, and non-transitory computer-readable medium described herein, the timer may be reset each instance that the count of recorded retransmission failures is updated, and where the count of recorded retransmission failures is reset upon expiration of the timer. Some examples of the method, UEs, and non-transitory computer-readable medium described herein may further include operations, features, means, or instructions for receiving configuration information for the radio link that indicates the PDU retransmission limit value, the count limit value, and a duration of the timer. In some examples of the method, UEs, and non-transitory computer-readable medium described herein, the radio link may be associated with low-latency traffic, and where radio links associated with non-low-latency traffic use different criteria to trigger the RLF.

In some examples of the method, UEs, and non-transitory computer-readable medium described herein, the PDU retransmission limit value may be based on a delay budget associated with the first PDU to provide that retransmissions of the first PDU are discontinued after a time period associated with the delay budget. In some examples of the method, UEs, and non-transitory computer-readable medium described herein, the radio link may be configured for acknowledged mode communications.

A method for wireless communications by an apparatus is described. The method may include transmitting to a UE, configuration information that indicates a delay budget associated with a radio link, the delay budget indicating a quantity of retransmissions of a PDU that are to be transmitted by the UE prior to the PDU becoming obsolete, where the configuration information further indicates that the UE is to trigger a RLF and initiate a connection re-establishment procedure for the radio link based on a quantity of recorded retransmission failures within a time duration exceeding a retransmission failure threshold value and communicating with the UE in accordance with the configuration information.

An apparatus for wireless communications is described. The apparatus may include one or more memories storing processor executable code, and one or more processors coupled with the one or more memories. The one or more processors may individually or collectively be operable to execute the code to cause the apparatus to transmit to a UE, configuration information that indicates a delay budget associated with a radio link, the delay budget indicating a quantity of retransmissions of a PDU that are to be transmitted by the UE prior to the PDU becoming obsolete, where the configuration information further indicates that the UE is to trigger a RLF and initiate a connection re-establishment procedure for the radio link based on a quantity of recorded retransmission failures within a time duration exceeding a retransmission failure threshold value and communicate with the UE in accordance with the configuration information.

Another apparatus for wireless communications is described. The apparatus may include means for transmitting to a UE, configuration information that indicates a delay budget associated with a radio link, the delay budget indicating a quantity of retransmissions of a PDU that are to be transmitted by the UE prior to the PDU becoming obsolete, where the configuration information further indicates that the UE is to trigger a RLF and initiate a connection re-establishment procedure for the radio link based on a quantity of recorded retransmission failures within a time duration exceeding a retransmission failure threshold value and means for communicating with the UE in accordance with the configuration information.

A non-transitory computer-readable medium storing code for wireless communications is described. The code may include instructions executable by one or more processors to transmit to a UE, configuration information that indicates a delay budget associated with a radio link, the delay budget indicating a quantity of retransmissions of a PDU that are to be transmitted by the UE prior to the PDU becoming obsolete, where the configuration information further indicates that the UE is to trigger a RLF and initiate a connection re-establishment procedure for the radio link based on a quantity of recorded retransmission failures within a time duration exceeding a retransmission failure threshold value and communicate with the UE in accordance with the configuration information.

In some examples of the method, apparatuses, and non-transitory computer-readable medium described herein, the time duration may be configured based on the delay budget. In some examples of the method, apparatuses, and non-transitory computer-readable medium described herein, the configuration information further indicates a PDU retransmission limit value for each PDU, and the retransmission failure threshold value. In some examples of the method, apparatuses, and non-transitory computer-readable medium described herein, the radio link may be associated with low-latency traffic, and where radio links associated with non-low-latency traffic use different criteria to trigger the RLF. In some examples of the method, apparatuses, and non-transitory computer-readable medium described herein, the PDU retransmission limit value may be based on a delay budget associated with the first PDU to provide that retransmissions of the first PDU are discontinued after a time period associated with the delay budget.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports radio link failure techniques for low-latency traffic in accordance with one or more aspects of the present disclosure.

FIG. 2 shows an example of a wireless communications system that supports radio link failure techniques for low-latency traffic in accordance with one or more aspects of the present disclosure.

FIG. 3 shows an example of a flow chart that supports radio link failure techniques for low-latency traffic in accordance with one or more aspects of the present disclosure.

FIG. 4 shows an example of a flow chart that supports radio link failure techniques for low-latency traffic in accordance with one or more aspects of the present disclosure.

FIGS. 5 and 6 show block diagrams of devices that support radio link failure techniques for low-latency traffic in accordance with one or more aspects of the present disclosure.

FIG. 7 shows a block diagram of a communications manager that supports radio link failure techniques for low-latency traffic in accordance with one or more aspects of the present disclosure.

FIG. 8 shows a diagram of a system including a device that supports radio link failure techniques for low-latency traffic in accordance with one or more aspects of the present disclosure.

FIGS. 9 and 10 show block diagrams of devices that support radio link failure techniques for low-latency traffic in accordance with one or more aspects of the present disclosure.

FIG. 11 shows a block diagram of a communications manager that supports radio link failure techniques for low-latency traffic in accordance with one or more aspects of the present disclosure.

FIG. 12 shows a diagram of a system including a device that supports radio link failure techniques for low-latency traffic in accordance with one or more aspects of the present disclosure.

FIGS. 13 through 15 show flowcharts illustrating methods that support radio link failure techniques for low-latency traffic in accordance with one or more aspects of the present disclosure.

### DETAILED DESCRIPTION

In extended reality (XR) applications (e.g., augmented reality (AR), virtual reality (VR)), packets that carry XR information between devices, such as between a user equipment (UE) and a network entity, may have a delay budget that is relatively short, such as between 30-50 ms. After expiration of the delay budget, the packet may be obsolete and no longer of use to the XR application. For example, a first frame that exceeds the delay budget may be superseded by a second frame such that the first frame is no longer useful because it contains stale data (e.g., orientation data for a device that is superseded by more recent orientation data). However, current radio link failure (RLF) procedures may involve a relatively large quantity of retransmissions before RLF is declared. In XR applications, this may result in a packet that may be retransmitted multiple times after the packet is already obsolete, which may waste resources and consumes battery life.

In accordance with various aspects discussed herein, one or more RLF criteria may be provided and associated with relatively low-latency applications, such as XR applications. In some aspects, the RLF criteria may provide that when a radio link control (RLC) protocol data unit (PDU) of a low-latency RLC entity has been transmitted for a certain quantity of times (e.g., a quantity of times associated with a maximum retransmission threshold (maxRetxThreshold)), the UE should remove this PDU from a retransmission buffer at the UE, and record one retransmission failure. In some cases, the UE may trigger a RLF and initiate a radio resource control (RRC) connection reestablishment procedure based on a time-window-based condition. In some examples, the time-window-based condition may provide that a network entity configures a triggering threshold (K) and a time window (T1), which starts upon configuration of the time window by RRC. If there are at least K retransmission failures with a time window (T1), RLF may be triggered and a RRC connection reestablishment procedure initiated. Otherwise, the UE may start a new time window after an end of the current time window. In some other cases, the UE may trigger a RLF and initiate a RRC connection reestablishment procedure based on a counter-based condition. In some examples, the counter-based condition may provide that the UE maintains a counter for each RLC entity enabled with the RLF criterion. The network entity may configure a threshold (e.g., maximum) value for the counter and a timer (T2). In the event of a transmission or retransmission failure, the UE may increment the counter by one and start or restart the timer. If the counter reaches the configured threshold value, UE may trigger RLF and initiate RRC connection reestablishment. When the timer expires, if the counter has not reached the configured threshold value, UE may reset the counter and continue with the procedure.

Aspects of the disclosure are initially described in the context of wireless communications systems. Aspects of the disclosure are further illustrated by and described with reference to apparatus diagrams, system diagrams, and flowcharts that relate to RLF techniques for low-latency traffic.

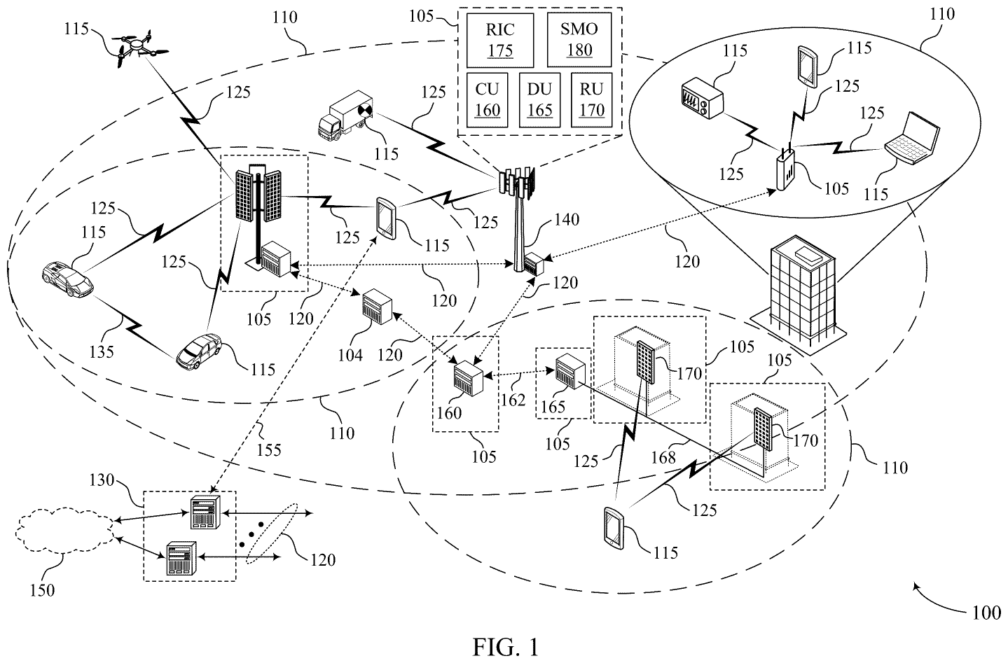

FIG. 1 shows an example of a wireless communications system 100 that supports RLF techniques for low-latency traffic in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., RLC layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In accordance with various aspects discussed herein, one or more RLF criteria may be provided and associated with relatively low-latency applications, such as XR applications. In some aspects, the RLF criteria may provide that when a RLC PDU of a low-latency RLC entity has been transmitted for a certain quantity of times (e.g., a quantity of times associated with a maximum retransmission threshold (maxRetxThreshold)), the UE 115 should remove this RLC PDU from a retransmission buffer at the UE 115, and record one retransmission failure. In some cases, the UE 115 may trigger a RLF and initiate a RRC connection reestablishment procedure based on a time-window-based condition. In some examples, the time-window-based condition may provide that a network entity configures a triggering threshold (K) and a time window (T1), which starts upon configuration of the time window by RRC. If there are at least K retransmission failures with the time window, RLF may be triggered and a RRC connection reestablishment procedure initiated. Otherwise, the UE 115 may start a new time window after an end of the current time window. In some other cases, the UE 115 may trigger a RLF and initiate a RRC connection reestablishment procedure based on a counter-based condition. In some examples, the counter-based condition may provide that the UE 115 maintains a counter for each RLC entity enabled with the RLF criterion. The network entity may configure a threshold value for the counter and a timer (T2). In the event of a transmission or retransmission failure, the UE may increment the counter by one and start or restart the timer. If the counter reaches the configured threshold value, UE 115 may trigger RLF and initiate RRC connection reestablishment. When the timer expires, if the counter has not reached the configured threshold value, UE 115 may reset the counter and continue with the procedure.

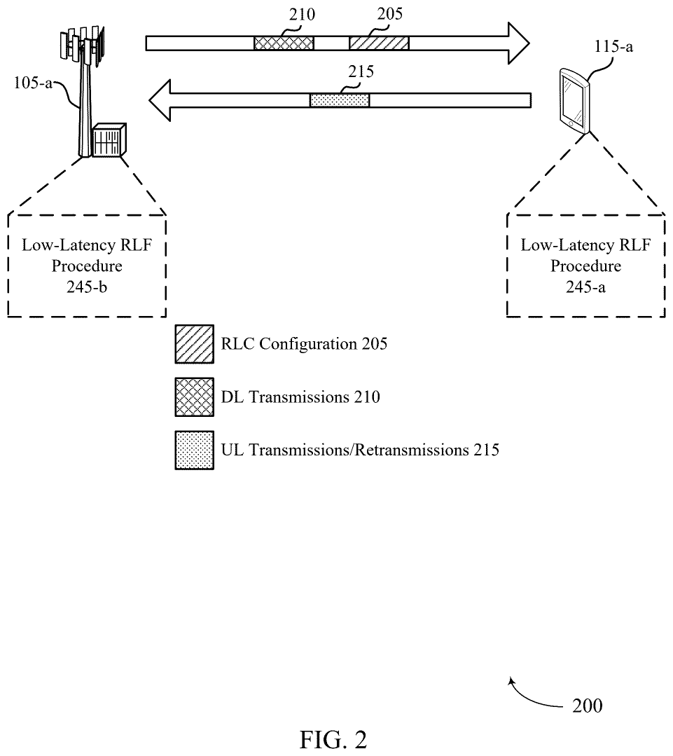

FIG. 2 shows an example of a wireless communications system 200 that supports RLF techniques for low-latency traffic in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

In some examples of wireless communications system 200, the UE 115-a and the network entity 105-a may communicate one or more uplink and downlink transmissions. For example, the UE 115-a may receive a RLC configuration 205 and one or more downlink transmissions 210. In some examples, the RLC configuration 205 may configure an RLC entity at the UE 115-a with RLF parameters as discussed herein. The UE 115-a may transmit one or more uplink transmissions and/or retransmissions 215 to the network entity 105-a in accordance with the RLC configuration 205. The UE 115-a may, as part of uplink and downlink communications according the RLC configuration 205, perform low-latency RLF procedure 245-a. Likewise, the network entity 105-a, as part of uplink and downlink communications according the RLC configuration 205, may perform low-latency RLF procedure 245-b. In some examples, the downlink transmissions 210 and the uplink transmissions and/or retransmissions 215 may include one or more PDUs associated with XR communications that are latency-sensitive. Additionally, while FIG. 2 illustrates the UE 115-a receiving the RLC configuration 205 and downlink transmissions 210, and transmitting uplink transmissions and/or retransmissions 215, to a same network entity 105-a, it is understood that the UE 115-a may communicate portions of such communications with multiple network entities 105.

As discussed herein for traditional communications, for a data radio bearer (DRB) configured with acknowledged mode (AM) communications (e.g., communications in which there is an acknowledgment of a reception of a PDU, coupled with retransmissions of unacknowledged PDUs), if a quantity of RLC retransmissions for a RLC PDU reaches a configured threshold (e.g., a maxRetxThreshold value), RLF may be triggered. When RLF is triggered, a UE 115 may abandon a current serving cell and perform a RRC reestablishment procedure to find a new serving cell. Such a procedure results in a substantial disruption to communications and is thus “expensive,” and in many deployments may be avoided unless RLF is truly beneficial. For this reason, network operators may configure a relatively large value for the configured threshold (e.g., maxRetxThreshold), to avoid triggering RLF unless communications have severely degraded. However, as discussed herein, for low-latency traffic, such as XR traffic, a relatively large value for the configured threshold results in inefficiencies for low-latency traffic, which may be associated with a delay budget (e.g., 30˜50 msec) that is approximately equivalent with a round-trip time of RLC retransmission. This means that even after RLC PDUs become obsolete after the RLC PDUs run out of delay budget, the transmitter may still keep transmitting the RLC PDUs in accordance with existing retransmission procedures, which may result in waste of radio resources.

In accordance with various aspects discussed herein, UE 115-a may avoid unnecessary retransmissions, while still providing for trigger of RLF when substantially degraded performance is experienced. In some aspects, a threshold quantity of retransmissions for each particular PDU may be limited, such that the UE 115-a may refrain from retransmitting a PDU on multiple occasions after a delay budget associated with the PDU elapses, while also providing that RLF is not triggered immediately when the transmitter reaches the threshold quantity of retransmissions (e.g., maxRetxThreshold). In such aspects, RLF may be triggered after the threshold quantity of retransmissions for multiple different PDUs is reached. In some aspects, the network entity 105-a may configure whether a RLC entity follows a low-latency RLF criterion (e.g., depending on whether the DRB associated with the RLC entity has low latency traffic or not), or whether the RLC entity follows a traditional non-low-latency RLF criterion.

In some aspects, for a RLC entity enabled with the low-latency RLF criterion, when the UE 115-a has transmitted a RLC PDU a quantity of times that corresponds to a configured threshold value (e.g., maxRetxThreshold), the UE 115-a may remove this PDU from the retransmission buffer and record one retransmission failure. In some cases, the configured threshold value may correspond to a quantity of retransmissions that may be attempted within a delay budget associated with PDUs transmitted via the RLC entity.

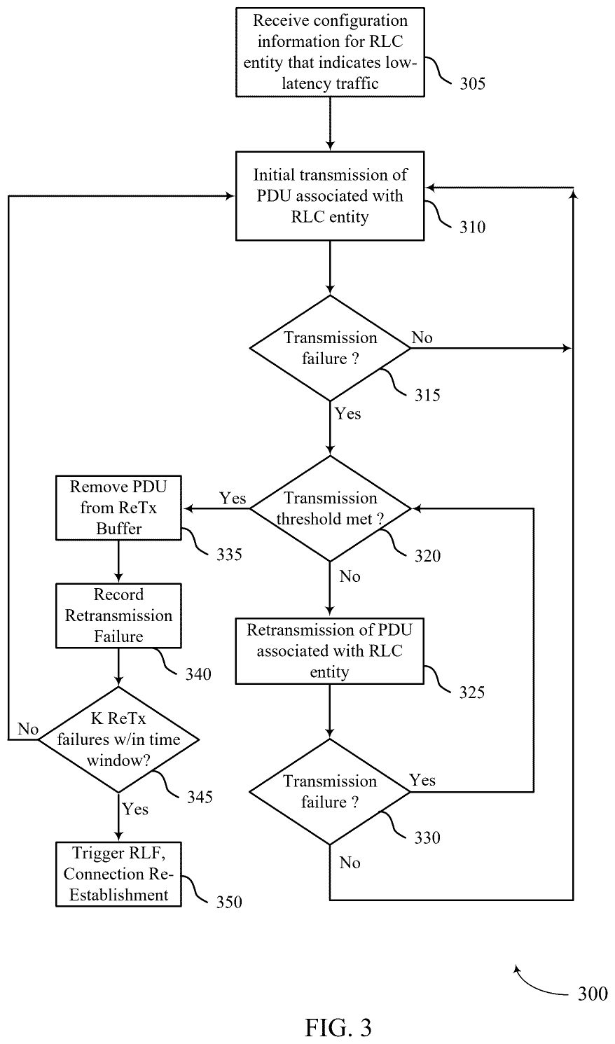

In some aspects, RLF may be triggered based on a time-window-based condition. In such aspects, the network entity 105-a may configure a triggering threshold (e.g., K) and a time window (e.g., T1), which starts upon configuration of the time window by RRC. If there are at least K retransmission failures with the time window T1, RLF may be triggered and a RRC reestablishment procedure may be initiated. Otherwise, the UE 115-a may start a new time window after a current time window elapses. An example of such an RLF technique is illustrated in FIG. 3.

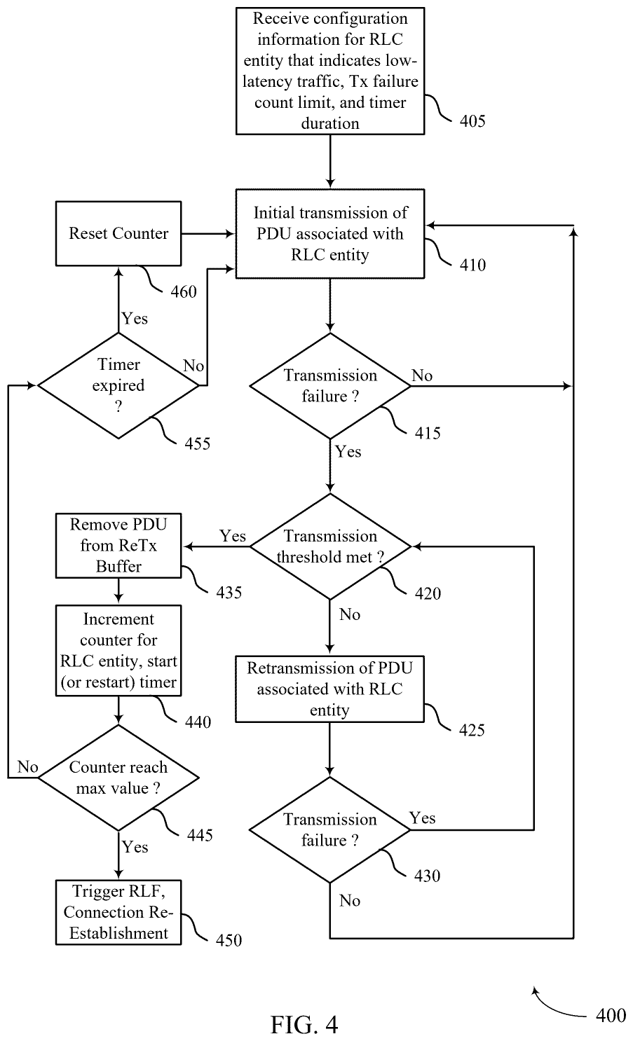

In some other aspects, RLF may be triggered based on a counter-based condition. In such aspects, the UE 115-a may maintain a counter for each RLC entity enabled with the low-latency RLF criterion. The network entity 105-a may configure a threshold (e.g., maximum) value for the counter and a timer (e.g., T2). Whenever there is a retransmission failure, the UE 115-a may increment the counter by one and start or restart the timer. If the counter reaches the configured threshold value, the UE 115-a may trigger RLF and initiate a RRC connection reestablishment procedure. When the timer expires, if the counter has not reached the configured threshold value, the UE 115-a may reset the counter to zero. An example of such an RLF technique is illustrated in FIG. 4.

FIG. 3 shows an example of a flow chart 300 that supports RLF techniques for low-latency traffic in accordance with one or more aspects of the present disclosure. In some examples, flow chart 300 may implement aspects of wireless communications system 100 or wireless communications system 200. Flow chart 400 may be implemented by a UE, which may be an example of UEs 115, as described with reference to FIGS. 1 and 2. Alternative examples of the following may be implemented, where some steps may be performed in a different order than described or may not be performed at all. In some cases, steps may include additional features not mentioned below, or further steps may be added. In addition, it is understood that these processes may occur between any quantity of network devices and network device types.

At 305, the UE may receive configuration information for a RLC entity that indicates low-latency traffic. In some cases, different configuration information may be provided for low-latency traffic versus non-low latency traffic. In some cases, the UE may receive the configuration via RRC signaling, although the UE may receive such configuration in other signaling in addition to, or alternatively to, RRC signaling (e.g., via system information, downlink control information, one or more MAC control elements, etc.).

At 310, the UE may transmit an initial transmission of a PDU associated with the RLC entity. The UE may transmit the PDU for a DRB associated with the RLC entity, for example, and the PDU may include data associated with a low-latency application (e.g., an XR application).

At 315, the UE may determine whether there was a transmission failure of the PDU. For example, the RLC entity may be configured for AM communications, and the UE may identify a transmission failure based on a negative acknowledgment from a receiving RLC entity. In the event that there is not a transmission failure (e.g., an acknowledgment for the PDU is received at the UE), operations at 310 may be continued for one or more other PDUs.

If the UE determines that there was a transmission failure of the PDU, at 320 the UE may determine if a transmission threshold is met. For example, the configuration information may indicate the transmission threshold value (e.g., K, which may be an integer value greater than or equal to one). If the transmission threshold has not been met, the UE may perform a retransmission of the PDU associated with the RLC entity, as indicated at 325. At 330, the UE may determine whether the retransmitted PDU has a transmission failure (e.g., based on a negative acknowledgment). In the event of a failure of the retransmission, operations at 320 may be continued. If a transmission failure is not present after one or more retransmissions, operations at 310 may be continued for one or more other PDUs.

If the UE determines that the transmission threshold is met at 320, the UE may remove the associated PDU from a retransmission buffer, as indicated at 335. At 340, the UE may record a retransmission failure (e.g., may increment or decrement a counter). At 345, the UE may determine whether a threshold quantity (e.g., K) of retransmission failures have been recorded within a time window (e.g., a time window T1 that may be provided in the configuration information that configures the RLC entity). At 350, if the threshold quantity of retransmission failures has been recorded, the UE may trigger RLF, and initiate a RRC connection reestablishment procedure. If the threshold quantity of retransmission quantities has not been recorded within the time window, operations at 310 may be continued.

FIG. 4 shows an example of a flow chart 400 that supports RLF techniques for low-latency traffic in accordance with one or more aspects of the present disclosure. In some examples, flow chart 400 may implement aspects of wireless communications system 100 or wireless communications system 200. Flow chart 400 may be implemented by a UE, which may be an example of UEs 115, as described with reference to FIGS. 1 and 2. Alternative examples of the following may be implemented, where some steps are performed in a different order than described or are not performed at all. In some cases, steps may include additional features not mentioned below, or further steps may be added. In addition, it is understood that these processes may occur between any quantity of network devices and network device types.

At 405, the UE may receive configuration information for a RLC entity that indicates low-latency traffic. In some cases, the configuration information may indicate a transmission failure count limit, and a timer duration. In some cases, different configuration information may be provided for low-latency traffic versus non-low latency traffic. In some cases, the UE may receive the configuration via RRC signaling, although the UE may receive such configuration in other signaling in addition to, or alternatively to, RRC signaling (e.g., via system information, downlink control information, one or more MAC control elements, etc.).

At 410, the UE may transmit an initial transmission of a PDU associated with the RLC entity. The UE may transmit the PDU for a DRB associated with the RLC entity, for example, and the PDU may include data associated with a low-latency application (e.g., an XR application).

At 415, the UE may determine whether there was a transmission failure of the PDU. For example, the RLC entity may be configured for AM communications, and the UE may identify a transmission failure based on a negative acknowledgment from a receiving RLC entity. In the event that there is not a transmission failure (e.g., an acknowledgment for the PDU is received at the UE), operations at 410 may be continued for one or more other PDUs.

If the UE determines that there was a transmission failure of the PDU, at 420 the UE may determine if a transmission threshold is met. For example, the configuration information may indicate the transmission threshold value (e.g., K, which may be an integer value greater than or equal to one). If the transmission threshold has not been met, the UE may perform a retransmission of the PDU associated with the RLC entity, as indicated at 425. At 430, the UE may determine whether the retransmitted PDU has a transmission failure (e.g., based on a negative acknowledgment). In the event of a failure of the retransmission, operations at 420 may be continued. If a transmission failure is not present after one or more retransmissions, operations at 410 may be continued for one or more other PDUs.

If the UE determines that the transmission threshold is met at 420, the UE may remove the associated PDU from a retransmission buffer, as indicated at 435. At 440, the UE may record a retransmission failure (e.g., may increment (or decrement) a counter), and start or restart an associated timer (e.g., T2). At 445, the UE may determine whether the counter has reached a threshold value (e.g., or has been decremented to zero from an initial maximum value). At 450, if the counter has reached the threshold value (or decremented to zero) prior to an expiration of the timer, the UE may trigger RLF, and initiate a RRC connection reestablishment procedure. If the threshold quantity of retransmission quantities has not been recorded within the time window, operations at 410 may be continued. If the counter has not reached the threshold value (or decremented to zero), at 455 the UE may determine whether the timer has expired. If the timer has not expired, operations at 410 are continued. If the timer has expired, at 460 the UE may reset the timer, and operations at 410 are continued.

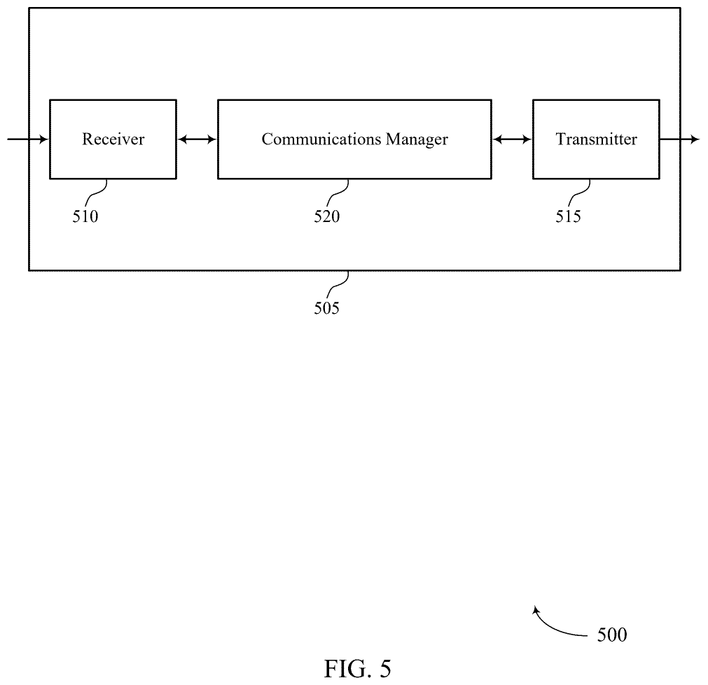

FIG. 5 shows a block diagram 500 of a device 505 that supports RLF techniques for low-latency traffic in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to RLF techniques for low-latency traffic). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to RLF techniques for low-latency traffic). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of RLF techniques for low-latency traffic as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting two or more instances of a first protocol data unit (PDU) via a radio link, the two or more instances of the first PDU including an initial transmission of the first PDU and one or more retransmissions of the first PDU. The communications manager 520 is capable of, configured to, or operable to support a means for removing the first PDU from a retransmission buffer based on a determination that a quantity of retransmissions of the first PDU meets a PDU retransmission limit value. The communications manager 520 is capable of, configured to, or operable to support a means for recording a retransmission failure based on the determination that the quantity of retransmissions of the first PDU meets the PDU retransmission limit value. The communications manager 520 is capable of, configured to, or operable to support a means for triggering a RLF and initiating a connection re-establishment procedure for the radio link based on a quantity of recorded retransmission failures within a time duration exceeding a retransmission failure threshold value.

Additionally, or alternatively, the communications manager 520 may support wireless communications in accordance with examples as disclosed herein. For example, the communications manager 520 is capable of, configured to, or operable to support a means for transmitting two or more instances of a first protocol data unit (PDU) via a radio link, the two or more instances of the first PDU including an initial transmission of the first PDU and one or more retransmissions of the first PDU. The communications manager 520 is capable of, configured to, or operable to support a means for removing the first PDU from a retransmission buffer based on a determination that a quantity of retransmissions of the first PDU meets a PDU retransmission limit value. The communications manager 520 is capable of, configured to, or operable to support a means for recording a retransmission failure based on the determination that the quantity of retransmissions of the first PDU meets the PDU retransmission limit value. The communications manager 520 is capable of, configured to, or operable to support a means for triggering a RLF and initiating a connection re-establishment procedure for the radio link based on a count of recorded retransmission failures that meets a count limit value prior to an expiration of a timer.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for PDU retransmissions and triggering RLF that avoids wasteful retransmissions of low-latency PDUs and also avoids premature triggering of RLF, which may enhance communications efficiency, reduce power consumption (associated with multiple retransmission), and enhance user experience.

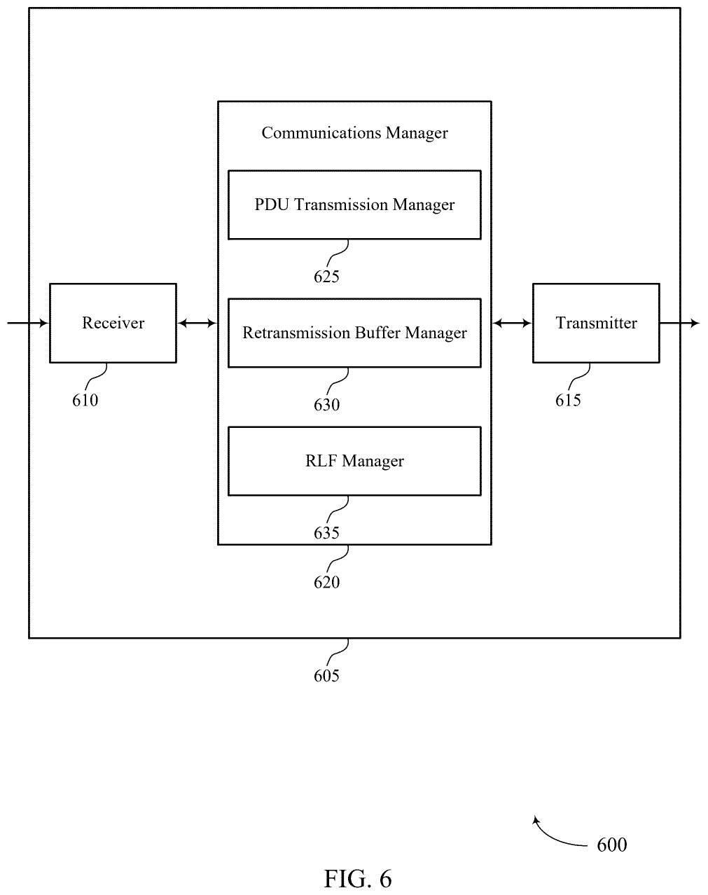

FIG. 6 shows a block diagram 600 of a device 605 that supports RLF techniques for low-latency traffic in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to RLF techniques for low-latency traffic). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RLF techniques for low-latency traffic). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of RLF techniques for low-latency traffic as described herein. For example, the communications manager 620 may include a PDU transmission manager 625, a retransmission buffer manager 630, an RLF manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The PDU transmission manager 625 is capable of, configured to, or operable to support a means for transmitting two or more instances of a first protocol data unit (PDU) via a radio link, the two or more instances of the first PDU including an initial transmission of the first PDU and one or more retransmissions of the first PDU. The retransmission buffer manager 630 is capable of, configured to, or operable to support a means for removing the first PDU from a retransmission buffer based on a determination that a quantity of retransmissions of the first PDU meets a PDU retransmission limit value. The RLF manager 635 is capable of, configured to, or operable to support a means for recording a retransmission failure based on the determination that the quantity of retransmissions of the first PDU meets the PDU retransmission limit value. The RLF manager 635 is capable of, configured to, or operable to support a means for triggering a RLF and initiating a connection re-establishment procedure for the radio link based on a quantity of recorded retransmission failures within a time duration exceeding a retransmission failure threshold value.

Additionally, or alternatively, the communications manager 620 may support wireless communications in accordance with examples as disclosed herein. The PDU transmission manager 625 is capable of, configured to, or operable to support a means for transmitting two or more instances of a first protocol data unit (PDU) via a radio link, the two or more instances of the first PDU including an initial transmission of the first PDU and one or more retransmissions of the first PDU. The retransmission buffer manager 630 is capable of, configured to, or operable to support a means for removing the first PDU from a retransmission buffer based on a determination that a quantity of retransmissions of the first PDU meets a PDU retransmission limit value. The RLF manager 635 is capable of, configured to, or operable to support a means for recording a retransmission failure based on the determination that the quantity of retransmissions of the first PDU meets the PDU retransmission limit value. The RLF manager 635 is capable of, configured to, or operable to support a means for triggering a RLF and initiating a connection re-establishment procedure for the radio link based on a count of recorded retransmission failures that meets a count limit value prior to an expiration of a timer.

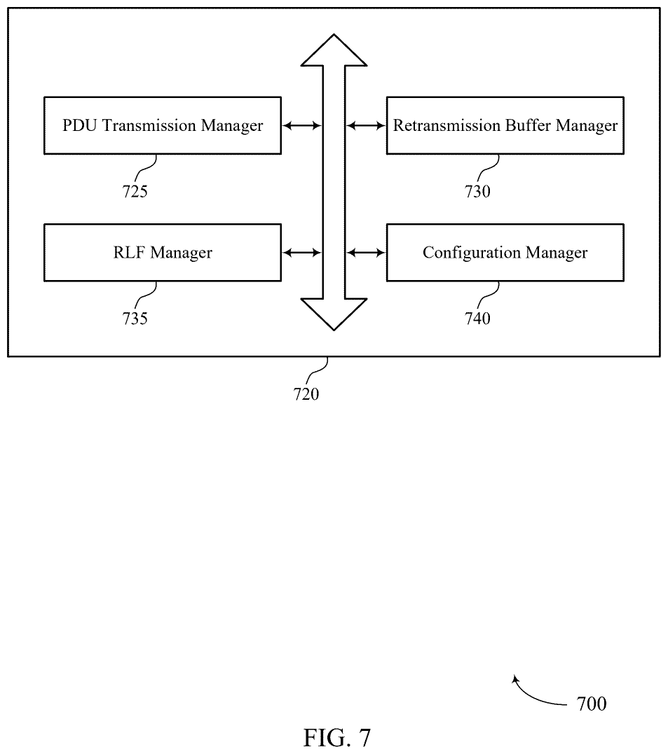

FIG. 7 shows a block diagram 700 of a communications manager 720 that supports RLF techniques for low-latency traffic in accordance with one or more aspects of the present disclosure. The communications manager 720 may be an example of aspects of a communications manager 520, a communications manager 620, or both, as described herein. The communications manager 720, or various components thereof, may be an example of means for performing various aspects of RLF techniques for low-latency traffic as described herein. For example, the communications manager 720 may include a PDU transmission manager 725, a retransmission buffer manager 730, an RLF manager 735, a configuration manager 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The PDU transmission manager 725 is capable of, configured to, or operable to support a means for transmitting two or more instances of a first protocol data unit (PDU) via a radio link, the two or more instances of the first PDU including an initial transmission of the first PDU and one or more retransmissions of the first PDU. The retransmission buffer manager 730 is capable of, configured to, or operable to support a means for removing the first PDU from a retransmission buffer based on a determination that a quantity of retransmissions of the first PDU meets a PDU retransmission limit value. The RLF manager 735 is capable of, configured to, or operable to support a means for recording a retransmission failure based on the determination that the quantity of retransmissions of the first PDU meets the PDU retransmission limit value. In some examples, the RLF manager 735 is capable of, configured to, or operable to support a means for triggering a RLF and initiating a connection re-establishment procedure for the radio link based on a quantity of recorded retransmission failures within a time duration exceeding a retransmission failure threshold value.

In some examples, the time duration is configured based on a delay budget associated with the first PDU.

In some examples, the configuration manager 740 is capable of, configured to, or operable to support a means for receiving configuration information for the radio link that indicates the PDU retransmission limit value and the retransmission failure threshold value.

In some examples, the radio link is associated with low-latency traffic, and where radio links associated with non-low-latency traffic use different criteria to trigger the RLF.

In some examples, the configuration information for the radio link further indicates the time duration.

In some examples, the PDU retransmission limit value is based on a delay budget associated with the first PDU to provide that retransmissions of the first PDU are discontinued after a time period associated with the delay budget.

In some examples, the RLF manager 735 is capable of, configured to, or operable to support a means for resetting a count of retransmission failures when the time duration expires, and initiating a subsequent count of retransmission failures in a subsequent time duration.

In some examples, the radio link is configured for AM communications.

Additionally, or alternatively, the communications manager 720 may support wireless communications in accordance with examples as disclosed herein. In some examples, the PDU transmission manager 725 is capable of, configured to, or operable to support a means for transmitting two or more instances of a first protocol data unit (PDU) via a radio link, the two or more instances of the first PDU including an initial transmission of the first PDU and one or more retransmissions of the first PDU. In some examples, the retransmission buffer manager 730 is capable of, configured to, or operable to support a means for removing the first PDU from a retransmission buffer based on a determination that a quantity of retransmissions of the first PDU meets a PDU retransmission limit value. In some examples, the RLF manager 735 is capable of, configured to, or operable to support a means for recording a retransmission failure based on the determination that the quantity of retransmissions of the first PDU meets the PDU retransmission limit value. In some examples, the RLF manager 735 is capable of, configured to, or operable to support a means for triggering a RLF and initiating a connection re-establishment procedure for the radio link based on a count of recorded retransmission failures that meets a count limit value prior to an expiration of a timer.

In some examples, the timer is reset each instance that the count of recorded retransmission failures is updated, and where the count of recorded retransmission failures is reset upon expiration of the timer.

In some examples, the configuration manager 740 is capable of, configured to, or operable to support a means for receiving configuration information for the radio link that indicates the PDU retransmission limit value, the count limit value, and a duration of the timer.

In some examples, the radio link is associated with low-latency traffic, and where radio links associated with non-low-latency traffic use different criteria to trigger the RLF.

In some examples, the PDU retransmission limit value is based on a delay budget associated with the first PDU to provide that retransmissions of the first PDU are discontinued after a time period associated with the delay budget.

In some examples, the radio link is configured for AM communications.

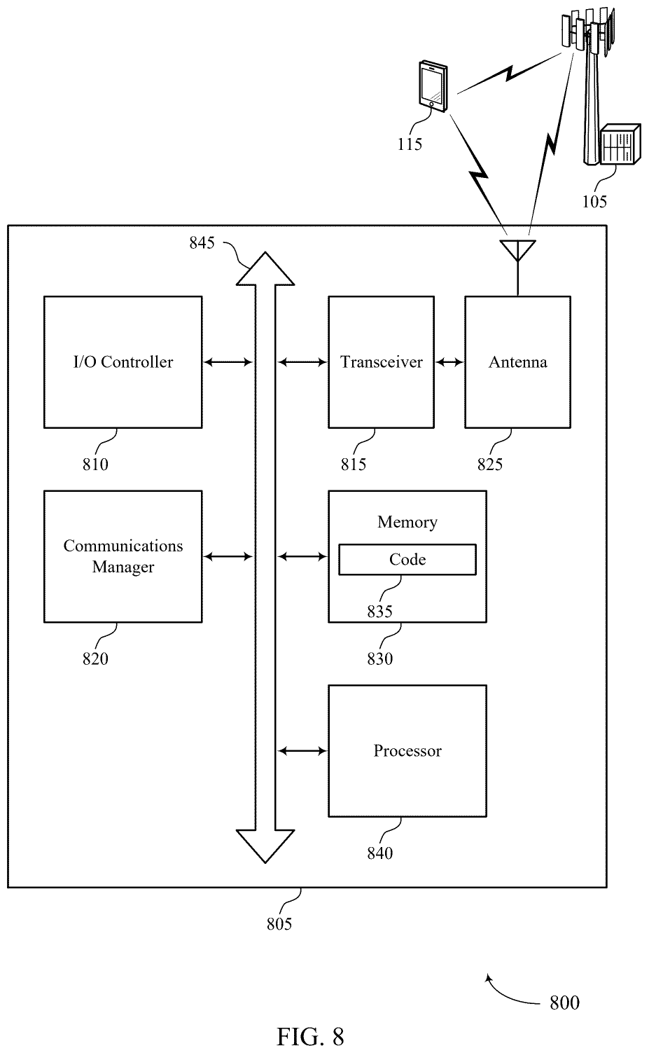

FIG. 8 shows a diagram of a system 800 including a device 805 that supports RLF techniques for low-latency traffic in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting RLF techniques for low-latency traffic). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting two or more instances of a first protocol data unit (PDU) via a radio link, the two or more instances of the first PDU including an initial transmission of the first PDU and one or more retransmissions of the first PDU. The communications manager 820 is capable of, configured to, or operable to support a means for removing the first PDU from a retransmission buffer based on a determination that a quantity of retransmissions of the first PDU meets a PDU retransmission limit value. The communications manager 820 is capable of, configured to, or operable to support a means for recording a retransmission failure based on the determination that the quantity of retransmissions of the first PDU meets the PDU retransmission limit value. The communications manager 820 is capable of, configured to, or operable to support a means for triggering a RLF and initiating a connection re-establishment procedure for the radio link based on a quantity of recorded retransmission failures within a time duration exceeding a retransmission failure threshold value.

Additionally, or alternatively, the communications manager 820 may support wireless communications in accordance with examples as disclosed herein. For example, the communications manager 820 is capable of, configured to, or operable to support a means for transmitting two or more instances of a first protocol data unit (PDU) via a radio link, the two or more instances of the first PDU including an initial transmission of the first PDU and one or more retransmissions of the first PDU. The communications manager 820 is capable of, configured to, or operable to support a means for removing the first PDU from a retransmission buffer based on a determination that a quantity of retransmissions of the first PDU meets a PDU retransmission limit value. The communications manager 820 is capable of, configured to, or operable to support a means for recording a retransmission failure based on the determination that the quantity of retransmissions of the first PDU meets the PDU retransmission limit value. The communications manager 820 is capable of, configured to, or operable to support a means for triggering a RLF and initiating a connection re-establishment procedure for the radio link based on a count of recorded retransmission failures that meets a count limit value prior to an expiration of a timer.

By including or configuring the communications manager 820 in accordance with examples as described herein, the device 805 may support techniques for PDU retransmissions and triggering RLF that avoids wasteful retransmissions of low-latency PDUs and also avoids premature triggering of RLF, which may enhance communications efficiency, reduce power consumption (associated with multiple retransmission), and enhance user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of RLF techniques for low-latency traffic as described herein, or the at least one processor 840 and the at least one memory 830 may be otherwise configured to, individually or collectively, perform or support such operations.

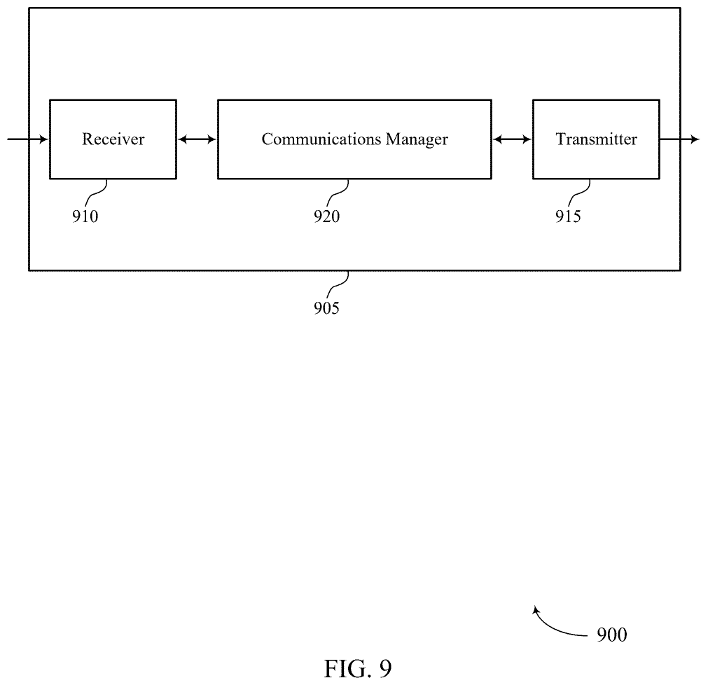

FIG. 9 shows a block diagram 900 of a device 905 that supports RLF techniques for low-latency traffic in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of RLF techniques for low-latency traffic as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting to a UE, configuration information that indicates a delay budget associated with a radio link, the delay budget indicating a quantity of retransmissions of a protocol data unit (PDU) that are to be transmitted by the UE prior to the PDU becoming obsolete, where the configuration information further indicates that the UE is to trigger a RLF and initiate a connection re-establishment procedure for the radio link based on a quantity of recorded retransmission failures within a time duration exceeding a retransmission failure threshold value. The communications manager 920 is capable of, configured to, or operable to support a means for communicating with the UE in accordance with the configuration information.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for PDU retransmissions and triggering RLF that avoids wasteful retransmissions of low-latency PDUs and also avoids premature triggering of RLF, which may enhance communications efficiency, reduce power consumption (associated with multiple retransmission), and enhance user experience.

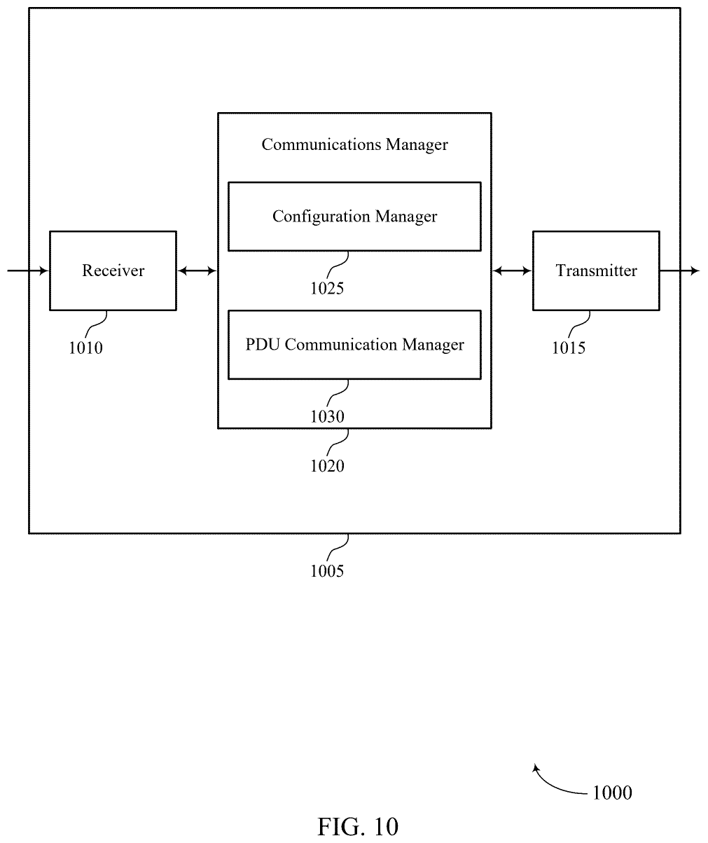

FIG. 10 shows a block diagram 1000 of a device 1005 that supports RLF techniques for low-latency traffic in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of RLF techniques for low-latency traffic as described herein. For example, the communications manager 1020 may include a configuration manager 1025 a PDU communication manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration manager 1025 is capable of, configured to, or operable to support a means for transmitting to a UE, configuration information that indicates a delay budget associated with a radio link, the delay budget indicating a quantity of retransmissions of a protocol data unit (PDU) that are to be transmitted by the UE prior to the PDU becoming obsolete, where the configuration information further indicates that the UE is to trigger a RLF and initiate a connection re-establishment procedure for the radio link based on a quantity of recorded retransmission failures within a time duration exceeding a retransmission failure threshold value. The PDU communication manager 1030 is capable of, configured to, or operable to support a means for communicating with the UE in accordance with the configuration information.

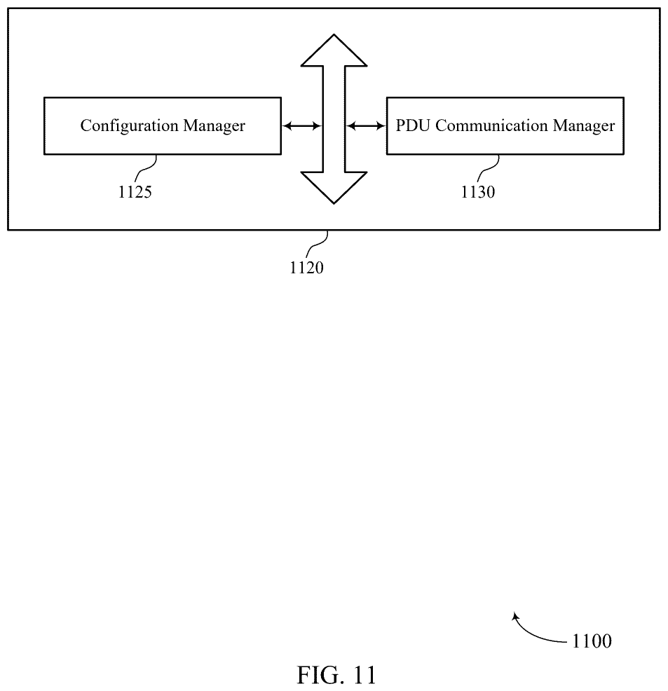

FIG. 11 shows a block diagram 1100 of a communications manager 1120 that supports RLF techniques for low-latency traffic in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of RLF techniques for low-latency traffic as described herein. For example, the communications manager 1120 may include a configuration manager 1125 a PDU communication manager 1130, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration manager 1125 is capable of, configured to, or operable to support a means for transmitting to a UE, configuration information that indicates a delay budget associated with a radio link, the delay budget indicating a quantity of retransmissions of a protocol data unit (PDU) that are to be transmitted by the UE prior to the PDU becoming obsolete, where the configuration information further indicates that the UE is to trigger a RLF and initiate a connection re-establishment procedure for the radio link based on a quantity of recorded retransmission failures within a time duration exceeding a retransmission failure threshold value. The PDU communication manager 1130 is capable of, configured to, or operable to support a means for communicating with the UE in accordance with the configuration information.

In some examples, the time duration is configured based on a delay budget associated with the PDU.

In some examples, the configuration information further indicates a PDU retransmission limit value for each PDU, and the retransmission failure threshold value.

In some examples, the radio link is associated with low-latency traffic, and where radio links associated with non-low-latency traffic use different criteria to trigger the RLF.

In some examples, the PDU retransmission limit value is based on a delay budget associated with the first PDU to provide that retransmissions of the first PDU are discontinued after a time period associated with the delay budget.

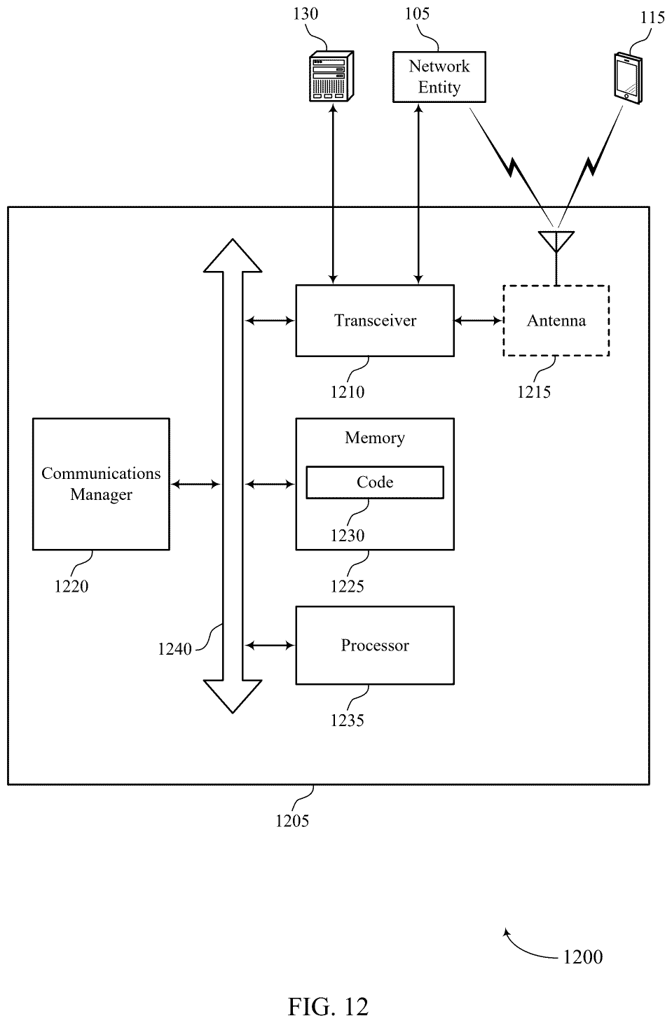

FIG. 12 shows a diagram of a system 1200 including a device 1205 that supports RLF techniques for low-latency traffic in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting RLF techniques for low-latency traffic). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting to a UE, configuration information that indicates a delay budget associated with a radio link, the delay budget indicating a quantity of retransmissions of a protocol data unit (PDU) that are to be transmitted by the UE prior to the PDU becoming obsolete, where the configuration information further indicates that the UE is to trigger a RLF and initiate a connection re-establishment procedure for the radio link based on a quantity of recorded retransmission failures within a time duration exceeding a retransmission failure threshold value. The communications manager 1220 is capable of, configured to, or operable to support a means for communicating with the UE in accordance with the configuration information.

By including or configuring the communications manager 1220 in accordance with examples as described herein, the device 1205 may support techniques for PDU retransmissions and triggering RLF that avoids wasteful retransmissions of low-latency PDUs and also avoids premature triggering of RLF, which may enhance communications efficiency, reduce power consumption (associated with multiple retransmission), and enhance user experience.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of RLF techniques for low-latency traffic as described herein, or the at least one processor 1235 and the at least one memory 1225 may be otherwise configured to, individually or collectively, perform or support such operations.

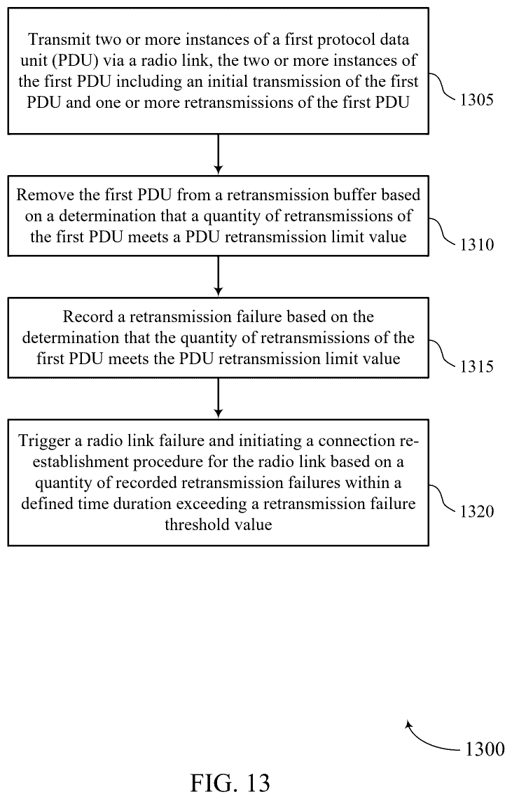

FIG. 13 shows a flowchart illustrating a method 1300 that supports RLF techniques for low-latency traffic in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting two or more instances of a first protocol data unit (PDU) via a radio link, the two or more instances of the first PDU including an initial transmission of the first PDU and one or more retransmissions of the first PDU. The operations of 1305 may be performed in accordance with examples as disclosed herein. In some examples, aspects of the operations of 1305 may be performed by a PDU transmission manager 725 as described with reference to FIG. 7.

At 1310, the method may include removing the first PDU from a retransmission buffer based on a determination that a quantity of retransmissions of the first PDU meets a PDU retransmission limit value. The operations of 1310 may be performed in accordance with examples as disclosed herein. In some examples, aspects of the operations of 1310 may be performed by a retransmission buffer manager 730 as described with reference to FIG. 7.

At 1315, the method may include recording a retransmission failure based on the determination that the quantity of retransmissions of the first PDU meets the PDU retransmission limit value. The operations of 1315 may be performed in accordance with examples as disclosed herein. In some examples, aspects of the operations of 1315 may be performed by an RLF manager 735 as described with reference to FIG. 7.

At 1320, the method may include triggering a RLF and initiating a connection re-establishment procedure for the radio link based on a quantity of recorded retransmission failures within a time duration exceeding a retransmission failure threshold value. The operations of 1320 may be performed in accordance with examples as disclosed herein. In some examples, aspects of the operations of 1320 may be performed by an RLF manager 735 as described with reference to FIG. 7.

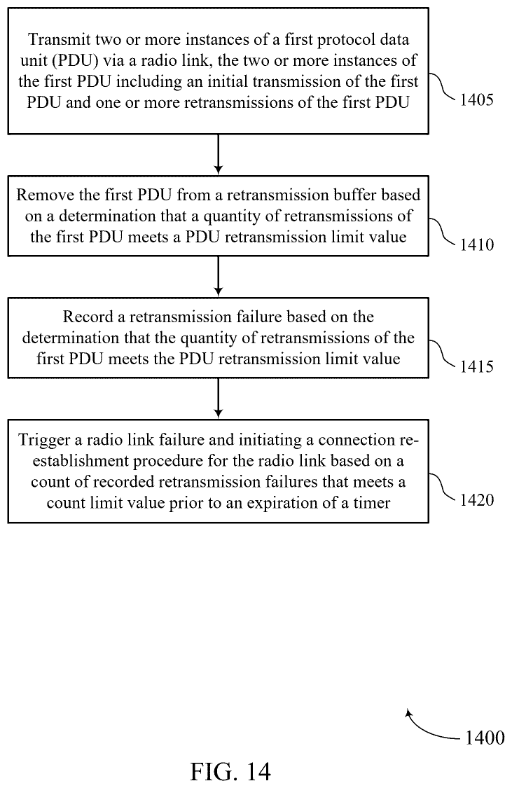

FIG. 14 shows a flowchart illustrating a method 1400 that supports RLF techniques for low-latency traffic in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting two or more instances of a first protocol data unit (PDU) via a radio link, the two or more instances of the first PDU including an initial transmission of the first PDU and one or more retransmissions of the first PDU. The operations of 1405 may be performed in accordance with examples as disclosed herein. In some examples, aspects of the operations of 1405 may be performed by a PDU transmission manager 725 as described with reference to FIG. 7.

At 1410, the method may include removing the first PDU from a retransmission buffer based on a determination that a quantity of retransmissions of the first PDU meets a PDU retransmission limit value. The operations of 1410 may be performed in accordance with examples as disclosed herein. In some examples, aspects of the operations of 1410 may be performed by a retransmission buffer manager 730 as described with reference to FIG. 7.

At 1415, the method may include recording a retransmission failure based on the determination that the quantity of retransmissions of the first PDU meets the PDU retransmission limit value. The operations of 1415 may be performed in accordance with examples as disclosed herein. In some examples, aspects of the operations of 1415 may be performed by an RLF manager 735 as described with reference to FIG. 7.

At 1420, the method may include triggering a RLF and initiating a connection re-establishment procedure for the radio link based on a count of recorded retransmission failures that meets a count limit value prior to an expiration of a timer. The operations of 1420 may be performed in accordance with examples as disclosed herein. In some examples, aspects of the operations of 1420 may be performed by an RLF manager 735 as described with reference to FIG. 7.

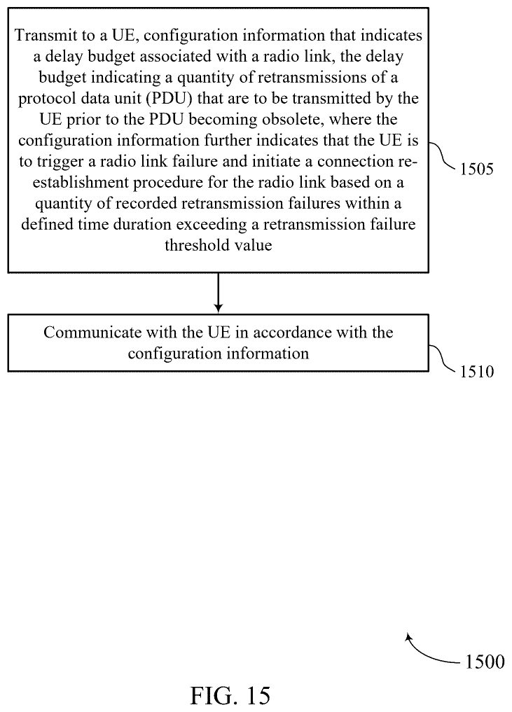

FIG. 15 shows a flowchart illustrating a method 1500 that supports RLF techniques for low-latency traffic in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting to a UE, configuration information that indicates a delay budget associated with a radio link, the delay budget indicating a quantity of retransmissions of a protocol data unit (PDU) that are to be transmitted by the UE prior to the PDU becoming obsolete, where the configuration information further indicates that the UE is to trigger a RLF and initiate a connection re-establishment procedure for the radio link based on a quantity of recorded retransmission failures within a time duration exceeding a retransmission failure threshold value. The operations of 1505 may be performed in accordance with examples as disclosed herein. In some examples, aspects of the operations of 1505 may be performed by a configuration manager 1125 as described with reference to FIG. 11.

At 1510, the method may include communicating with the UE in accordance with the configuration information. The operations of 1510 may be performed in accordance with examples as disclosed herein. In some examples, aspects of the operations of 1510 may be performed by a PDU communication manager 1130 as described with reference to FIG. 11.

The following provides an overview of aspects of the present disclosure:
Aspect 1: A method for wireless communications at a UE, comprising: transmitting two or more instances of a first protocol data unit (PDU) via a radio link, the two or more instances of the first PDU including an initial transmission of the first PDU and one or more retransmissions of the first PDU; removing the first PDU from a retransmission buffer based at least in part on a determination that a quantity of retransmissions of the first PDU meets a PDU retransmission limit value; recording a retransmission failure based at least in part on the determination that the quantity of retransmissions of the first PDU meets the PDU retransmission limit value; and triggering a RLF and initiating a connection re-establishment procedure for the radio link based at least in part on a quantity of recorded retransmission failures within a time duration exceeding a retransmission failure threshold value.
Aspect 2: The method of aspect 1, wherein the time duration is configured based on a delay budget associated with the first PDU.
Aspect 3: The method of aspect 1, further comprising: receiving configuration information for the radio link that indicates the PDU retransmission limit value and the retransmission failure threshold value.
Aspect 4: The method of aspect 3, wherein the radio link is associated with low-latency traffic, and wherein radio links associated with non-low-latency traffic use different criteria to trigger the RLF.
Aspect 5: The method of any of aspects 3 through 4, wherein the configuration information for the radio link further indicates the time duration.
Aspect 6: The method of any of aspects 1 through 5, wherein the PDU retransmission limit value is based at least in part on a delay budget associated with the first PDU to provide that retransmissions of the first PDU are discontinued after a time period associated with the delay budget.
Aspect 7: The method of any of aspects 1 through 6, further comprising: resetting a count of retransmission failures when the time duration expires, and initiating a subsequent count of retransmission failures in a subsequent time duration.
Aspect 8: The method of any of aspects 1 through 7, wherein the radio link is configured for AM communications.
Aspect 9: A method for wireless communications at a UE, comprising: transmitting two or more instances of a first protocol data unit (PDU) via a radio link, the two or more instances of the first PDU including an initial transmission of the first PDU and one or more retransmissions of the first PDU; removing the first PDU from a retransmission buffer based at least in part on a determination that a quantity of retransmissions of the first PDU meets a PDU retransmission limit value; recording a retransmission failure based at least in part on the determination that the quantity of retransmissions of the first PDU meets the PDU retransmission limit value; and triggering a RLF and initiating a connection re-establishment procedure for the radio link based at least in part on a count of recorded retransmission failures that meets a count limit value prior to an expiration of a timer.
Aspect 10: The method of aspect 9, wherein the timer is reset each instance that the count of recorded retransmission failures is updated, and wherein the count of recorded retransmission failures is reset upon expiration of the timer
Aspect 11: The method of any of aspects 9 through 10, further comprising: receiving configuration information for the radio link that indicates the PDU retransmission limit value, the count limit value, and a duration of the timer.
Aspect 12: The method of aspect 11, wherein the radio link is associated with low-latency traffic, and wherein radio links associated with non-low-latency traffic use different criteria to trigger the RLF.
Aspect 13: The method of any of aspects 9 through 12, wherein the PDU retransmission limit value is based at least in part on a delay budget associated with the first PDU to provide that retransmissions of the first PDU are discontinued after a time period associated with the delay budget.
Aspect 14: The method of any of aspects 9 through 13, wherein the radio link is configured for AM communications.
Aspect 15: A method for wireless communications, at a network entity comprising: transmitting to a UE, configuration information that indicates a delay budget associated with a radio link, the delay budget indicating a quantity of retransmissions of a protocol data unit (PDU) that are to be transmitted by the UE prior to the PDU becoming obsolete, wherein the configuration information further indicates that the UE is to trigger a RLF and initiate a connection re-establishment procedure for the radio link based at least in part on a quantity of recorded retransmission failures within a time duration exceeding a retransmission failure threshold value; and communicating with the UE in accordance with the configuration information.
Aspect 16: The method of aspect 15, wherein the configuration information further indicates a PDU retransmission limit value for each PDU, and the retransmission failure threshold value.
Aspect 17: The method of any of aspects 15 through 16, wherein the radio link is associated with low-latency traffic, and wherein radio links associated with non-low-latency traffic use different criteria to trigger the RLF.
Aspect 18: The method of any of aspects 15 through 17, wherein the PDU retransmission limit value is based at least in part on a delay budget associated with the first PDU to provide that retransmissions of the first PDU are discontinued after a time period associated with the delay budget.
Aspect 19: A UE for wireless communications, comprising one or more memories storing processor-executable code, and one or more processors coupled with the one or more memories and individually or collectively operable to execute the code to cause the UE to perform a method of any of aspects 1 through 8.
Aspect 20: A UE for wireless communications, comprising at least one means for performing a method of any of aspects 1 through 8.
Aspect 21: A non-transitory computer-readable medium storing code for wireless communications, the code comprising instructions executable by one or more processors to perform a method of any of aspects 1 through 8.
Aspect 22: A UE for wireless communications, comprising one or more memories storing processor-executable code, and one or more processors coupled with the one or more memories and individually or collectively operable to execute the code to cause the UE to perform a method of any of aspects 9 through 14.
Aspect 23: A UE for wireless communications, comprising at least one means for performing a method of any of aspects 9 through 14.
Aspect 24: A non-transitory computer-readable medium storing code for wireless communications, the code comprising instructions executable by one or more processors to perform a method of any of aspects 9 through 14.
Aspect 25: An apparatus for wireless communications, comprising one or more memories storing processor-executable code, and one or more processors coupled with the one or more memories and individually or collectively operable to execute the code to cause the apparatus to perform a method of any of aspects 15 through 18.
Aspect 26: An apparatus for wireless communications, comprising at least one means for performing a method of any of aspects 15 through 18.
Aspect 27: A non-transitory computer-readable medium storing code for wireless communications, the code comprising instructions executable by one or more processors to perform a method of any of aspects 15 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit two or more instances of a first protocol data unit (PDU) via a radio link, the two or more instances of the first PDU including an initial transmission of the first PDU and one or more retransmissions of the first PDU;
remove the first PDU from a retransmission buffer based at least in part on a determination that a quantity of retransmissions of the first PDU meets a PDU retransmission limit value;
record a retransmission failure based at least in part on the determination that the quantity of retransmissions of the first PDU meets the PDU retransmission limit value; and
trigger a radio link failure and initiating a connection re-establishment procedure for the radio link based at least in part on a quantity of recorded retransmission failures within a time duration exceeding a retransmission failure threshold value.

2. The UE of claim 1, wherein the time duration is configured based at least in part on a delay budget associated with the first PDU.

3. The UE of claim 1, wherein the one or more processors are individually or collectively further operable to execute the code to cause the UE to:
receive configuration information for the radio link that indicates the PDU retransmission limit value and the retransmission failure threshold value.

4. The UE of claim 3, wherein the radio link is associated with low-latency traffic, and wherein radio links associated with non-low-latency traffic use different criteria to trigger the radio link failure.

5. The UE of claim 3, wherein the configuration information for the radio link further indicates the time duration.

6. The UE of claim 1, wherein the PDU retransmission limit value is based at least in part on a delay budget associated with the first PDU to provide that retransmissions of the first PDU are discontinued after a time period associated with the delay budget.

7. The UE of claim 1, wherein the one or more processors are individually or collectively further operable to execute the code to cause the UE to:
reset a count of retransmission failures when the time duration expires, and initiating a subsequent count of retransmission failures in a subsequent time duration.

8. The UE of claim 1, wherein the radio link is configured for acknowledged mode communications.

9. A user equipment (UE), comprising:
one or more memories storing processor-executable code; and
one or more processors coupled with the one or more memories and individually or collectively operable to execute the code to cause the UE to:
transmit two or more instances of a first protocol data unit (PDU) via a radio link, the two or more instances of the first PDU including an initial transmission of the first PDU and one or more retransmissions of the first PDU;
remove the first PDU from a retransmission buffer based at least in part on a determination that a quantity of retransmissions of the first PDU meets a PDU retransmission limit value;
record a retransmission failure based at least in part on the determination that the quantity of retransmissions of the first PDU meets the PDU retransmission limit value; and
trigger a radio link failure and initiating a connection re-establishment procedure for the radio link based at least in part on a count of recorded retransmission failures that meets a count limit value prior to an expiration of a timer.

10. The UE of claim 9, wherein the timer is reset each instance that the count of recorded retransmission failures is updated, and wherein the count of recorded retransmission failures is reset upon expiration of the timer.

11. The UE of claim 9, wherein the one or more processors are individually or collectively further operable to execute the code to cause the UE to:
receive configuration information for the radio link that indicates the PDU retransmission limit value, the count limit value, and a duration of the timer.

12. The UE of claim 11, wherein the radio link is associated with low-latency traffic, and wherein radio links associated with non-low-latency traffic use different criteria to trigger the radio link failure.

13. The UE of claim 9, wherein the PDU retransmission limit value is based at least in part on a delay budget associated with the first PDU to provide that retransmissions of the first PDU are discontinued after a time period associated with the delay budget.

14. The UE of claim 9, wherein the radio link is configured for acknowledged mode communications.

15. A method for wireless communications at a user equipment (UE), comprising:
transmitting two or more instances of a first protocol data unit (PDU) via a radio link, the two or more instances of the first PDU including an initial transmission of the first PDU and one or more retransmissions of the first PDU;
removing the first PDU from a retransmission buffer based at least in part on a determination that a quantity of retransmissions of the first PDU meets a PDU retransmission limit value;
recording a retransmission failure based at least in part on the determination that the quantity of retransmissions of the first PDU meets the PDU retransmission limit value; and
triggering a radio link failure and initiating a connection re-establishment procedure for the radio link based at least in part on a quantity of recorded retransmission failures within a time duration exceeding a retransmission failure threshold value.

16. The method of claim 15, wherein the time duration is configured based at least in part on a delay budget associated with the first PDU.

17. The method of claim 15, further comprising:
receiving configuration information for the radio link that indicates the PDU retransmission limit value and the retransmission failure threshold value.

18. The method of claim 17, wherein the radio link is associated with low-latency traffic, and wherein radio links associated with non-low-latency traffic use different criteria to trigger the radio link failure.

19. The method of claim 15, wherein the PDU retransmission limit value is based at least in part on a delay budget associated with the first PDU to provide that retransmissions of the first PDU are discontinued after a time period associated with the delay budget.

20. The method of claim 15, further comprising:
resetting a count of retransmission failures when the time duration expires, and initiating a subsequent count of retransmission failures in a subsequent time duration.
